(19) United States
(12) Patent Application Publication
(10) Pub. No.: US 2014/0338348 A1
(43) Pub. Date: Nov. 20, 2014

(54) ROTARY PULSE DETONATION ENGINE

(71) Applicants: Daniel Guy POMERLEAU, Calgary (CA); Andrew Richard HICKS, Canmore (CA)

(72) Inventors: Daniel Guy Pomerleau, Calgary (CA); Andrew Richard Hicks, Canmore (CA)

(21) Appl. No.: 14/365,626

(22) PCT Filed: Dec. 17, 2012
(86) PCT No.: PCT/CA2012/001158

§ 371 Date: Jun. 14, 2014

Related U.S. Application Data
(60) Provisional application No. 61/646,137, filed on May 11, 2012.
(60) Provisional application No. 61/576,904, filed on Dec. 16, 2011.

(51) Int. Cl. F02K 7/06; F02K 9/97

(52) U.S. Cl. CPC F02K 7/06; F02K 9/97; F05D 2220/80
USPC 60/761; 60/200.1; 60/770

(57) ABSTRACT

This invention relates to devices for discharging high pressure exhaust, and in particular to pulse detonation engines. More specifically, the invention describes a rotary pulse detonation engine having a rotary valve system. The rotary valve includes a generally-triangular rotor having rotor tips within a rotor chamber having trochoid inner end surfaces and side surfaces. The rotor defines three working chambers defined by the rotor tips contacting the rotor surfaces. In operation, the rotor tips move in a circumferential direction around the rotor chamber as the rotor spins. During operation, each of the working chambers will sequentially pass through an intake interval, compression interval, expansion interval, and an exhaust interval to create and detonate compressed fuel air mixtures for effective release to an exhaust chamber and nozzle thereby creating a pulsed detonation sequence.

### FIELD OF THE INVENTION

This invention relates to devices for discharging high pressure exhaust, and in particular to pulse detonation engines. More specifically, the invention describes a rotary pulse detonation engine having a rotary valve system. The rotary valve includes a generally-triangular rotor having rotor tips within a rotor chamber having trochoid inner end surfaces and side surfaces. The rotor defines three working chambers defined by the rotor tips contacting the rotor surfaces. In operation, the rotor tips move in a circumferential direction around the rotor chamber as the rotor spins. During operation, each of the working chambers will sequentially pass through an intake interval, compression interval, expansion interval, and an exhaust interval to create and detonate compressed fuel air mixtures for effective release to an exhaust chamber and nozzle thereby creating a pulsed detonation sequence.

### BACKGROUND OF THE INVENTION

All regular jet engines and most rocket engines operate on the deflagration of fuel, that is, the rapid but subsonic combustion of fuel within a combustion chamber. The pulse detonation engine (PDE) is a concept currently in active development to create a jet engine that operates on the supersonic detonation of fuel.

The basic operation of the PDE is similar to that of the pulse jet engine. In a pulse jet engine, air is mixed with fuel to create a flammable mixture that is then ignited. The resulting combustion greatly increases the pressure of the mixture to as high as 100 atmospheres (10 MPa) (theoretical), which then expands through a nozzle for thrust. To ensure that the mixture exits to the rear end of the nozzle, thereby providing force in the desired direction (such as pushing an aircraft forward), a series of shutters are used to close off the front of the engine. Careful tuning of the inlet ensures the shutters close at the right time to force the air to travel in one direction only through the engine.

The main difference between a PDE and a traditional pulse jet engine is that the mixture does not undergo subsonic combustion but instead, supersonic detonation. In the PDE, the oxygen and fuel combustion process is supersonic, effectively an explosion instead of burning. In addition, in some PDE designs, the shutters are replaced by more sophisticated valves. In other PDE designs, the shutters are eliminated through careful timing, using the pressure differences between the different areas of the engine to ensure the “shot” is ejected rearwardly.

The main effect of the changes in the combustion cycle is that the PDE is considerably more efficient than a pulse jet engine. In the pulse jet engine the combustion process pushes a considerable amount of the fuel/air mix (the charge) out the rear of the engine before it has had a chance to burn (thus the trail of flame seen on the V-1 flying bomb). Even while inside the engine the mixture's volume is continually changing, which is an inefficient way to burn fuel. In contrast the PDE deliberately uses a high-speed combustion process that burns substantially all of the charge while it is still inside the engine at a constant volume.

Thus, the amount of heat produced per unit of fuel is generally higher than other engines, although in most PDE designs, conversion of that energy into thrust remains inefficient due to various restrictions/constrictions within the typical PDE engine.

Another problem with PDEs is that current designs use detonation waves to compress the fuel/air within the detonation chamber in order to increase the pressure, density and temperature of the fuel/air. Using this approach, as the frequency of detonations increases the time for detonation waves to compress the fuel/air is reduced thereby reducing the detonation energy. Further still, PDEs have chamber temperatures in the order of 3,500° F. which tends to cause premature failures of engine parts. Also, initiating repetitive detonations is a problem.

Another limitation of a traditional pulsejet engine is that the pulse frequency is maximal at about 250 pulses per second due to the cycle time of the mechanical shutters. In contrast, one objective of the PDE is operation at thousands of pulses per second, so fast that the operation is effectively continuous from an observer's perspective. Such operation would also have the advantage of minimizing vibration problems that occur with pulsejet engines. That is, small pulses will create less volume than a smaller number of larger pulses for the same net thrust. Unfortunately, detonation explosions are generally much louder than deflagration combustion.

As noted above, one significant problem with a pulse-detonation engine is starting the detonation. While it is possible to start a detonation directly with a large spark, the amount of energy input is large which can become impractical for many applications. In the past, the typical solution is to use a deflagration-to-detonation transition (DDT), that is, start a high-energy deflagration, and have it accelerate down a tube to the point where it becomes fast enough to become a detonation. Alternatively the detonation can be sent around a circle and valves ensure that only the highest peak power can leak into exhaust.

As can be appreciated, this process is highly complicated as a result of many factors including the resistance the advancing wave front encounters (similar to wave drag). Moreover, DDTs occur far more readily if there are obstacles in the tube. The most widely used is the “Shchelkin spiral”, which is designed to create the most useful eddies with the least resistance to the moving fuel/air/exhaust mixture. The eddies lead to the flame separating into multiple fronts, some of which go backwards and collide with other fronts, and then accelerate into fronts ahead of them. Importantly, this behaviour is difficult to model and to predict, and research is ongoing.

As with conventional pulsejets, there are two main types of designs in a PDE: valved and valveless. Designs with valves encounter the same difficult-to-resolve wear issues encountered with their pulsejet equivalents. Valveless designs typically rely on abnormalities in the air flow to ensure a one-way flow, and are very hard to achieve in regular DDT.

Other problems with pulse detonation engines are achieving DDT without requiring a tube long enough to make it impractical and drag-imposing on the aircraft; reducing the noise (often described as sounding like a jackhammer); and damping the severe vibration caused by the operation of the engine.

With the recent development of pulse detonation combustors (PDCs) and engines (PDEs), various efforts have been underway to use PDC/Es in practical applications, such as in aircraft engines and/or as means to generate additional thrust/propulsion. Further, there are efforts to employ PDC/E devices into “hybrid” type engines, which use a combination of both conventional gas turbine engine technology and PDC/E technology in an effort to maximize operational efficiency. Other examples include use in aircrafts, missiles, and rockets.

As with any engine that intakes air, inlet stability is an important aspect of maintaining proper operation of a pulse detonation engine. This presents a particular challenge in pulse detonation engines, which use open inlet tubes.

At high speeds, such as Mach 2 to about Mach 3.5, such an engine would be theoretically more efficient than conventional turbojets because the engine does not require compressors or turbines. A pulse detonation engine supplying the same amount or more of thrust as a conventional gas turbine engine would also theoretically weigh less.

Accordingly, there has been a need for improvements in PDE engine design that overcome many of the problems discussed above.

### SUMMARY OF THE INVENTION

In accordance with a first embodiment, there is provided a pulse detonation engine comprising: a rotor operatively contained within an oval chamber, the rotor having at least three rotor tips and a corresponding number of rotor surfaces between each rotor tip, the rotor rotatable within the oval chamber such that each rotor tip is engaged with the oval chamber as the rotor rotates within the oval chamber; wherein the rotor tips and rotor surfaces define at least three progressing chambers within the oval chamber; an eccentric lobe on a shaft operatively engaged with the rotor for biasing the rotor tips against the oval chamber; a fixed gear on the oval chamber for engagement with a corresponding inner gear on the rotor for defining the rotation path of the rotor within the oval chamber; a fuel injection system operatively connected to the oval chamber; an air inlet system adjacent the fuel injection system within the oval chamber; an ignition system within the oval chamber; an exhaust port; wherein as the rotor is rotated within the oval chamber, fuel and air are successively mixed, compressed and detonated wherein the resulting detonation force is ejected from the exhaust port.

In further embodiments, the exhaust port is configured to a gear or fan driven turbofan.

In another aspect, the exhaust port is configured to a ballistics barrel for providing a high velocity charge to a shell.

In another aspect, the invention is directed to the use of a pulse detonation engine as as a combustor within a jet engine.

In yet another aspect, the invention provides improvements in a jet engine having a combustion chamber, turbine and compression stages and an exhaust nozzle, the improvement comprising a rotary pulse detonation engine (RPDE) operatively configured to the combustion chamber for directing detonation exhaust from the RPDE against turbine blades of the turbine stage.

In another aspect, the invention provides improvements in a jet engine having a combustion chamber, turbine and compression stages and an exhaust nozzle, the improvement comprising a rotary pulse detonation engine (RPDE) operatively configured to the combustion chamber for directing detonation exhaust from the RPDE to the exhaust nozzle.

In another aspect the jet engine includes a supercharger operatively connected to the RPDE for increasing air flow into the RPDE.

In a still further aspect, the invention provides a hybrid jet and rocket engine comprising: a combustion chamber, turbine and compression stages and an exhaust nozzle, a rotary pulse detonation engine (RPDE) operatively configured to the combustion chamber for directing detonation exhaust from the RPDE to the combustion chamber during a jet engine mode of operation and to the exhaust nozzle during a rocket mode of operation; and, an intake manifold having a valve system selectively operable to direct atmospheric air to the RPDE during the jet engine mode of operation and to direct cryogenic oxidizer to the RPDE during the rocket mode of operation.

### BRIEF DESCRIPTION OF THE DRAWINGS

The invention is described with reference to the drawings in which:

FIG. 1 is a schematic diagram of a pulse detonation engine having a rotary valve in accordance with one embodiment of the invention;

FIG. 2 is a schematic diagram of a pulse detonation engine for use with ballistics;

FIG. 3 is a schematic front view of a pulse detonation jet engine having a rotary valve combustor in accordance with one embodiment of the invention;

FIG. 4 is a schematic side view of a pulse detonation jet engine having rotary valve combustors in accordance with one embodiment of the invention (not to scale);

FIG. 5 is a schematic side view of a pulse detonation jet engine having rotary valve combustors in accordance with one embodiment of the invention showing exhaust positions (not to scale);

FIG. 6 is a schematic side view of a pulse detonation jet engine showing the position of rotary valve combustors; and,

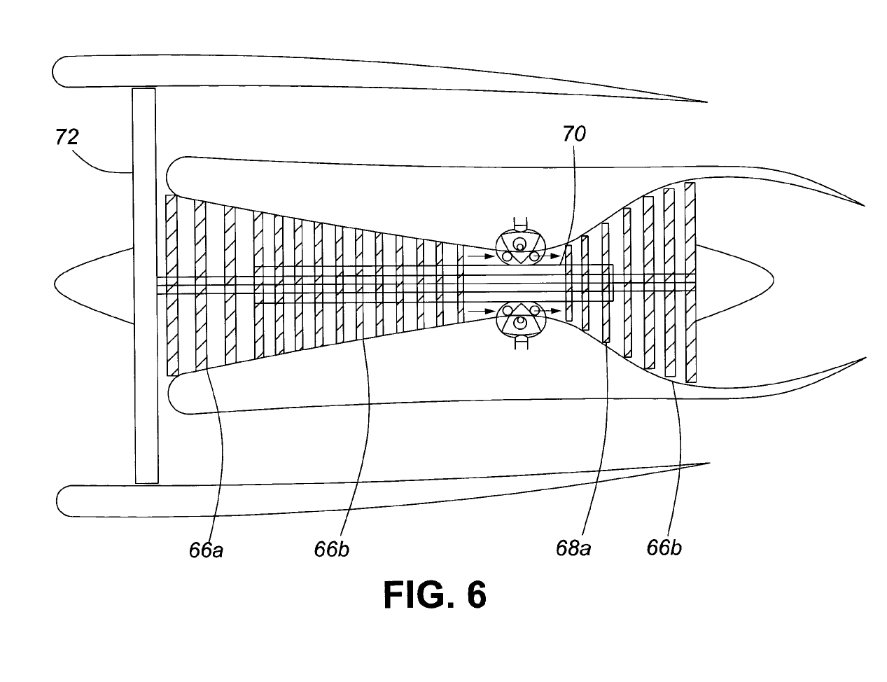

FIG. 7 is a schematic side view of a hybrid jet/rocket engine having rotary valve combustors in accordance with one embodiment of the invention.

### DETAILED DESCRIPTION OF THE INVENTION

With reference to the figures, a pulse detonation engine (PDE) is described having a rotating valve for high temperature and high pressure operation in a pulse detonation combustor.

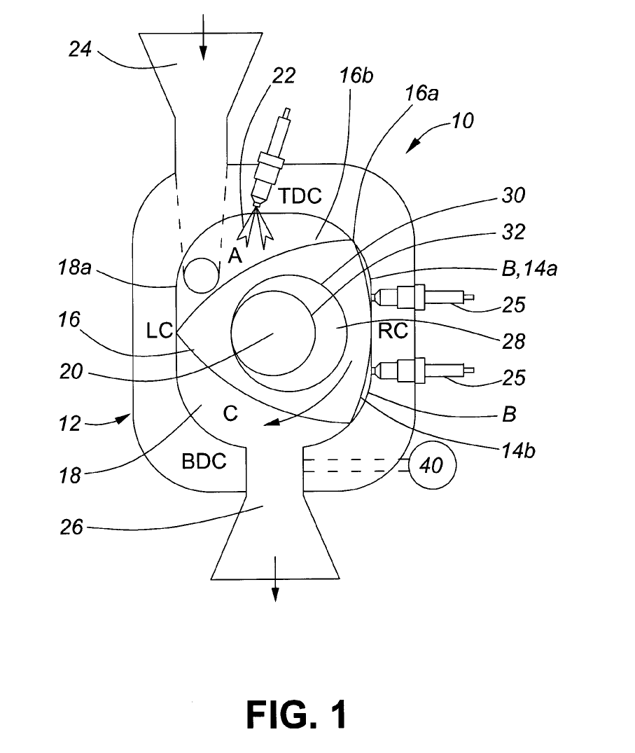

As shown in FIG. 1, the PDE 10 utilizes a rotary valve 12 and combustion chamber 14a, 14b of a Wankel-type rotary engine as the means for generating pulsed detonations of pressurized fuel/air.

More specifically, as is known, a Wankel-type engine is a variable volume processing cavity system in which a lobed rotor 16, having rotor tips 16a and rotor surfaces 16b is rotated within a generally oval chamber 18 having chamber walls 18a. As the lobed rotor is caused to rotate within the chamber about a central axis 20, the rotor tips trace the circumference of the oval chamber such that the rotor surfaces successively move towards and away from the oval chamber walls thereby defining different volumes at different locations within the chamber as the rotor progresses through a complete rotation. In a Wankel-type engine, the rotor has three rotor tips and three rotor surfaces thereby defining three volumes A, B, C between the rotor and oval chamber. For the purpose of general description, the rotor tips sequentially pass through four positions, left center (rotor tip adjacent the middle left wall of the oval chamber), top dead center (rotor tip adjacent the top curved surface of the oval chamber), right center (rotor tip adjacent the middle right wall of the oval chamber) and bottom dead center (rotor tip adjacent the bottom curved surface of the oval chamber).

In sequence, fuel 22 and air 24 are injected into the first volume at the top of the oval chamber where the chamber curvature is greatest and the first volume is maximal (first rotor tip left center). As the rotor is rotated and the first rotor tip passes through top dead center, the first volume becomes progressively smaller as the first lobed surface moves towards the right oval chamber wall (where the chamber curvature is minimal) thereby compressing the fuel and air mixture. At the position of generally maximum compression (ie. minimal first chamber volume shown as B) or slightly beyond maximum compression, the compressed mixture of fuel and air is combusted by an ignition source 25 (first rotor tip midway between right center and bottom dead center). The combustion force against the rotor causes rotation of the rotor wherein the first rotor tip moves towards the lower region of the oval chamber (again where oval chamber curvature is maximal) and the first volume chamber is expanding. As the first rotor tip passes through the bottom dead center position, the first volume once again begins to decrease wherein the combusted gases are expelled from the oval chamber through an exhaust port 26 located adjacent the bottom dead center position.

In the conventional Wankel engine, a drive shaft having eccentric lobes is configured to the rotor such that as the rotor progresses around the oval chamber, torque is applied to the eccentric lobes such that the drive shaft rotates. This is accomplished by a rotor gear 30, configured to the interior of the rotor rotating about a stationary gear 32 within the oval chamber. The eccentric lobes ensure that the rotor gear remain engaged with the stationary gear throughout each rotation.

In accordance with the invention, the foregoing design is used as a rotary valve to initiate and control pulse detonations that are exhausted from the engine through the exhaust port to provide propulsion forces. As such, the system provides an effective means of initiating and controlling multiple detonations.

The main difference between the operation and design of the system in accordance with one embodiment of the invention is that no drive load is placed on the rotor as the objective is not to contain the detonating fuel within the chamber but to permit the exploding fuel/air mixture to complete the detonation process within the exhaust system of the engine. That is, in a traditional rotary engine the purpose of combustion is to maximize the torque on the rotor and hence provide torque to the drive shaft. In comparison, in the subject system, while rotary motion is applied to the rotor by the detonation of fuel/air, the timing of the detonation relative to the rotor position is balanced such that the forces of the detonation are primarily expelled out the exhaust of the engine. In fact, the drive linkages (i.e. the eccentric rotor, stationary gear and rotor gear) may be actively controlled to affect timing within the system. That is, as the timing may substantially minimize torque on the rotor, the eccentric rotor may be actively driven to enable fuel compression.

Various advantages of the rotary pulse detonation engine design include:
sufficiently robust enough to endure billions of cycles;
enables configuration in a stacked or side-by-side design;
compression and volume can be adjusted through mechanical design and augmented by intake pressure, including the use of turbine compressors;
mechanical compression reduces the need for high energy ignition sources;
no shutters are required to direct exhaust;
supersonic detonation occurs without Deflagration Detonation Transition (DDT);
reduces the need for sophisticated valving and timing systems beyond those required for the conventional rotary engine;
fuel/air mixture can be efficiently controlled to ensure high efficiency and complete burning of charge;
produces a minimum of 3 pressure pulses per eccentric rotation (variations in rotor design could increase pulse count per rotation) of the rotor thereby permitting >1 KHz pulsing based on a rotor speed of 20,000 rpm;
reduction in vibrations;
reduced exhaust tube length compared to known PDE designs such as Shchelkin spirals;
allows for the use of augmenters and conventional afterburner technology to be incorporated;
can be incorporated into existing Turbofan designs replacing deflagration chambers;
operational frequency does not impair detonation efficiency;
high detonation temperatures of 3500°-4000° F. produce more thrust in Turbofan designs than the current 2100°-2700° F. systems

Generally, it is preferred that the detonation chamber has an elongated shape to improve the surface/volume (S/V ratio). This is generally achieved when the length of one side of the triangular face of the rotor L is at least 2.4 times the breadth of the rotor b (i.e L/b >2.4). With this ratio, an improvement in combustion stability and fuel efficiency is observed.

Further embodiments of the system are described below:

### Jet Engine Combustor

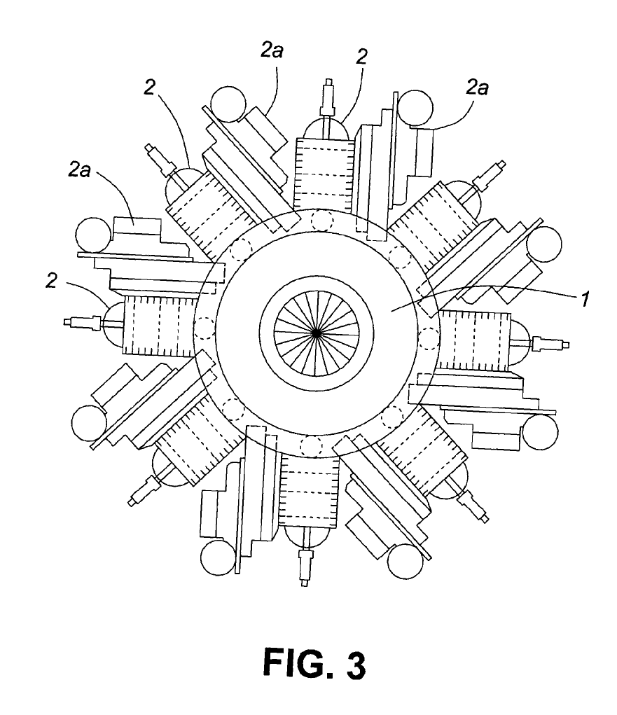

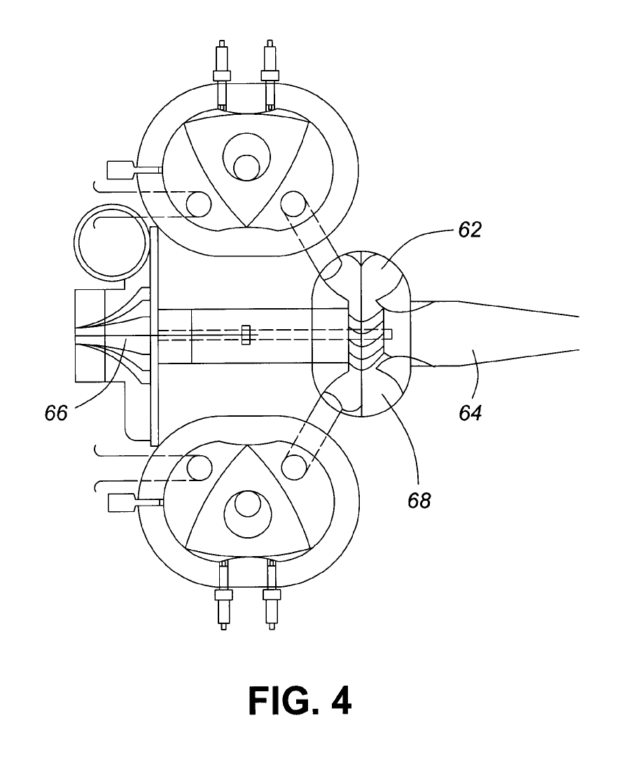

With reference to FIGS. 3-5, embodiments of a PDE engine are described in which a PDE rotary valve system 2 is utilized as a combustor within a jet turbine engine 1. As shown in these Figures, one or more PDE rotary valves 2 are positioned around the perimeter of a jet engine such that the PDE exhaust impinges upon the turbine blades 62 of the jet engine and/or directly into the exhaust nozzle 64 of the engine.

As is known, a conventional turbine engine includes a series of compressor 66 and exhaust 68 stages that in conjunction with the combustion of fuel within a combustion chamber 70 collectively generate propulsive thrust through the generation of high velocity exhaust and bypass thrust. Generally, a jet engine includes both high 66b and low 66a pressure compressors that feed compressed air into the combustion chamber 70 that upon combustion with fuel generate exhaust gases that are propelled through high 68a and low 68b pressure turbines generating rotational energy that is used to drive the high and low pressure compressors.

Combustion is deflagration combustion. In accordance with one embodiment of the invention, detonation exhaust from one or more PDE rotary valves is used to drive the turbine blades.

As is known, the general efficiency of jet engines is attributable to the combination of the high air/fuel ratio within the combustion chamber and other design considerations including the bypass thrust derived from bypass stages 72. Within the subject system, by providing the rotary valve system 2 in which detonation combustion occurs within the combustion chamber, higher velocity gas will impinge upon the turbine blades.

### Supercharger

In order to further enhance the thrust/efficiency of the engine, as shown in FIGS. 3-5, the PDE combustors 2 may be configured with superchargers 2a to provide additional supply of compressed air into the PDE combustors. Rotational energy for the superchargers may be supplied by rotational energy derived from the PDE combustors. Importantly, the superchargers will substantially increase the flow of compressed air into the PDE combustors which will enhance the detonation process.

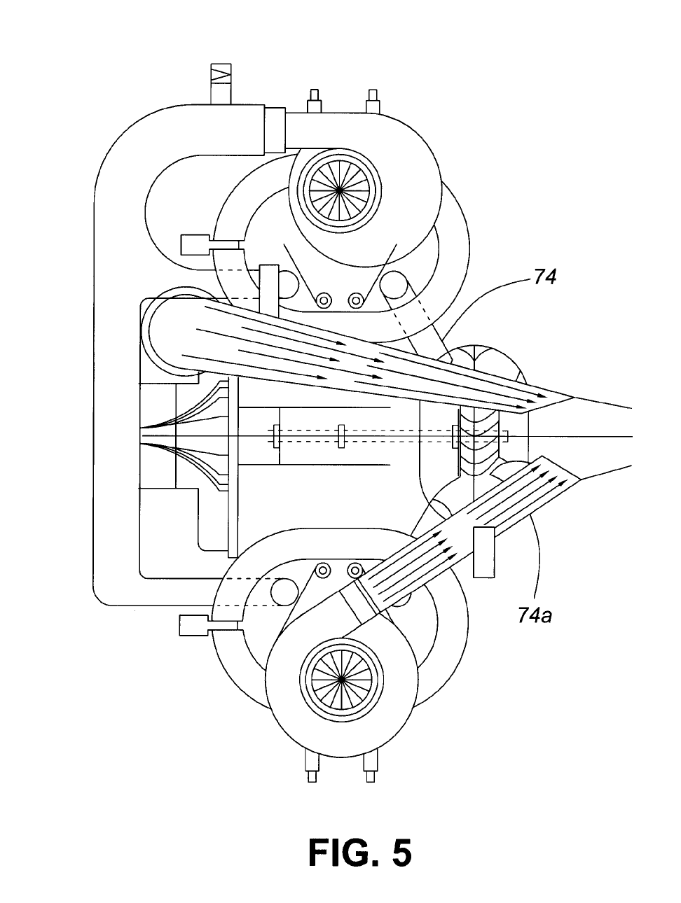

As shown in FIG. 5, additional configurations of superchargers may be employed to effect increased thrust from the engine by appropriate manifolds and outlets that may direct supercharger exhaust to areas of the engine other than the PDE combustors. For example, supercharger exhaust 74 may be input against the turbine blades to further increase the pressure on those blades. Alternatively, supercharger exhaust 74a may be input directly into the exhaust nozzle with or without an injection/ignition of additional fuel as an afterburner. Still further, supercharger exhaust may be introduced into the bypass airflow without or without injection/ignition of additional fuel if the engine is so configured in order to generate additional thrust.

### Hybrid Engine

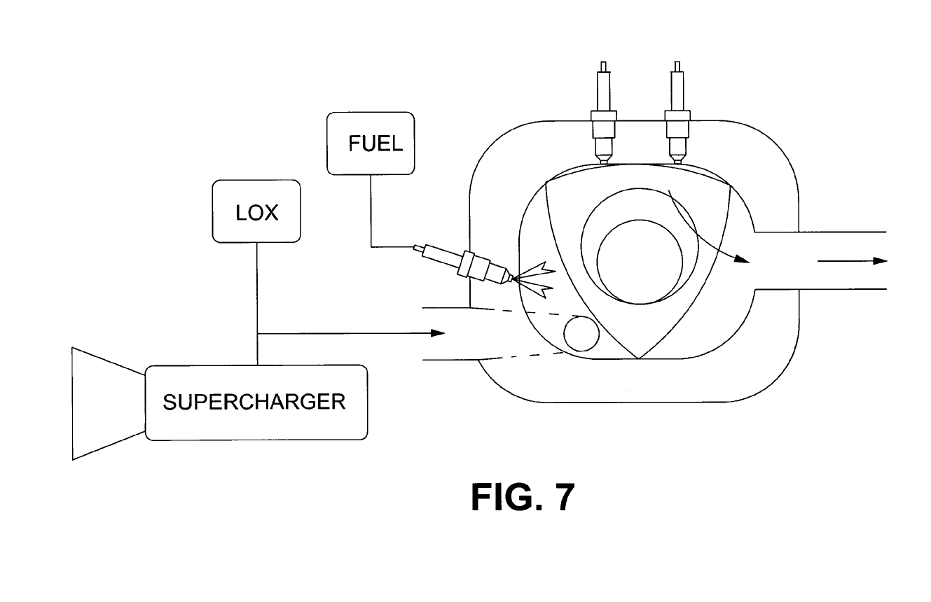

As shown in FIG. 7, the system may be further configured as a hybrid jet/rocket motor wherein appropriate manifolds and/or valves may utilize different oxidizer sources for the PDE combustors. In this embodiment, while operating within the atmosphere, atmospheric air may be directed through a supercharger and the PDE combustors with exhaust impinging on turbine blades as described above. When the engine is operating outside the atmosphere, valving may switch the oxidizer source to a liquid oxidizer (LOX) source and direct the exhaust directly to exhaust nozzle.

### Other Design Considerations

### Alternate Fuels

While the system has been described with the assumption that conventional hydrocarbon based fuels including gasoline, kerosene and natural gas type fuels are utilized, the system could potentially be used with non-conventional fuels such as nitromethane (CH₃NO₂) and other high explosives. In such a system, the high explosive may be combined with a conventional fuel through the use of an auxiliary injector 40 such that the conventional fuel initiates the detonation of the high explosive within the detonation chamber. Alternatively, in an alternate design, the high explosive fuel may be used independently of the conventional fuel. A second rotary valve sequenced to inject a secondary fuel may be utilized.

### Applications

The use of a high efficiency pulse detonation engine has applications in a wide range of technologies. These include supersonic and hypersonic propulsion for aircraft including almost any application for air or non-air breathing propulsion systems. The technology could also be utilized in conjunction with gear or fan driven turbofan engines as well as turboprop engines for subsonic applications.

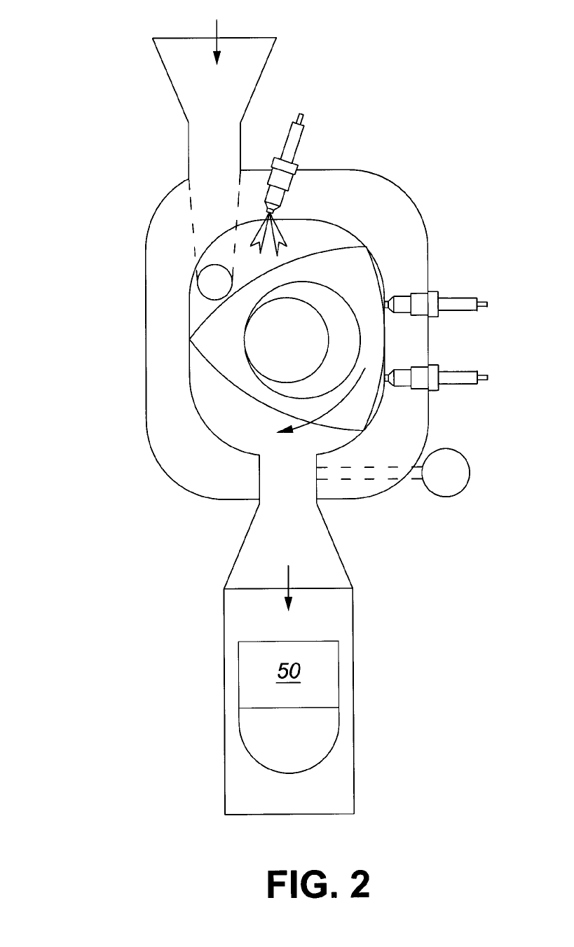

PDE technology in accordance with the invention could be used in ballistics applications including the high velocity delivery of projectiles 50 as shown in FIG. 2. Importantly, PDE technology could eliminate the need for a shell to include the charge and could enable the use of alternate fuels for machine guns, artillery etc.

1. A pulse detonation engine comprising:
a rotor operatively contained within an oval chamber, the rotor having at least three rotor tips and a corresponding number of rotor surfaces between each rotor tip, the rotor rotatable within the oval chamber such that each rotor tip is engaged with the oval chamber as the rotor rotates within the oval chamber; wherein the rotor tips and rotor surfaces define at least three progressing chambers within the oval chamber;
an eccentric lobe on a shaft operatively engaged with the rotor for biasing the rotor tips against the oval chamber;
a fixed gear on the oval chamber for engagement with a corresponding inner gear on the rotor for defining the rotation path of the rotor within the oval chamber;
a fuel injection system operatively connected to the oval chamber;
an oxidizer inlet system adjacent the fuel injection system within the oval chamber;
an ignition system within the oval chamber; and
an exhaust port;
wherein as the rotor is rotated within the oval chamber, fuel and air are successively mixed, compressed and detonated wherein the resulting detonation force is ejected from the exhaust port.

2. A pulse detonation engine as is in claim 1 wherein the exhaust port is configured to a gear or fan driven turbofan.

3. A pulse detonation engine as is in claim 1 wherein the exhaust port is configured to a ballistics barrel for providing a high velocity charge to a shell.

4. The use of a pulse detonation engine as in claim 1 as a combustor within a jet engine.

5. In a jet engine having a combustion chamber, turbine and compression stages and an exhaust nozzle, the improvement comprising a rotary pulse detonation engine (RPDE) operatively configured to the combustion chamber for directing detonation exhaust from the rotary pulse detonation engine against turbine blades of the turbine stage.

6. The jet engine as in claim 5 further comprising a supercharger operatively connected to the RPDE for increasing air flow into the RPDE.

7. In a jet engine having a combustion chamber, turbine and compression stages and an exhaust nozzle, the improvement comprising a rotary pulse detonation engine (RPDE) operatively configured to the combustion chamber for directing detonation exhaust from the RPDE to the exhaust nozzle.

8. The jet engine as in claim 7 further comprising a supercharger operatively connected to the RPDE for increasing air flow into the RPDE.

9. The jet engine as in claim 8 further comprising an afterburner.

10. A hybrid jet and rocket engine comprising:
a combustion chamber, turbine and compression stages and an exhaust nozzle,
a rotary pulse detonation engine (RPDE) operatively configured to the combustion chamber for directing detonation exhaust from the RPDE to the combustion chamber during a jet engine mode of operation and to the exhaust nozzle during a rocket mode of operation; and,
an intake manifold having a valve system selectively operable to direct atmospheric air to the RPDE during the jet engine mode of operation and to direct cryogenic oxidizer to the RPDE during the rocket mode of operation.

11. The jet engine as in claim 5 further comprising an afterburner.
